(19) United States
(12) Patent Application Publication
(10) Pub. No.: US 2023/0024200 A1
(43) Pub. Date: Jan. 26, 2023

(54) TERMINATING EMPTY JOINABLE GROUP CALLS

(71) Applicant: WhatsApp LLC, Menlo Park, CA (US)

(72) Inventors: Mattheus Christiaan Niks, San Francisco, CA (US); YuanYuan Wang, Los Altos, CA (US); Alexander Issayev, New York, NY (US)

(21) Appl. No.: 17/866,283

(22) Filed: Jul. 15, 2022

Related U.S. Application Data
(60) Provisional application No. 63/222,894, filed on Jul. 16, 2021.

(51) Int. Cl. H04L 65/1069; H04L 65/1093

(52) U.S. Cl. CPC H04L 65/1069; H04L 65/1093

(57) ABSTRACT

Methods, systems, and storage media for terminating empty joinable group calls are disclosed. Exemplary implementations may: determine, at a first point in time, that there are at least two connected participants in a joinable group call; determine, at a second point in time that is later than the first point in time, that there is a single connected participant in the joinable group call; based on determining, at the second point in time, that there is the single connected participant in the joinable group call, automatically terminate the joinable group call; transmit a termination message to each participant of the joinable group call; and cause display of the termination message on a respective device associated with each participant of the joinable group call.

### CROSS-REFERENCE TO RELATED APPLICATIONS

This present application claims the benefit of priority under 35 U.S.C. § 119(e) to U.S. Provisional Patent Application No. 63/222,894, filed Jul. 16, 2021, the disclosure of which is hereby incorporated by reference in its entirety for all purposes.

### TECHNICAL FIELD

The present disclosure generally relates to joinable group calls. More particularly, the present disclosure relates to terminating joinable group calls when active participants are no longer connected.

### BACKGROUND

Typical group call systems rely on the device of the last connected call participant to end a group call (e.g., an audio and/or video call). However, if the device of the last connected call participant loses connection (e.g., due to a dead battery, a change in reception, an improper closing of the group call app, or the like) and cannot or does not properly terminate the call, the group call may continue to be considered and viewable as active, even if nobody is on the call any longer.

In the past, this was not particularly problematic because users didn't have a list of “active” calls in their app. As such, whether a call was considered active or not was not known to users. However, with the introduction of joinable group calls (that is, group calls that permit invited participants to connect and disconnect at will as long as the call remains active), systems may display all, or at least some, active calls in the app so that users are aware of which calls they have been invited to participate in are joinable and which calls are not.

Accordingly, if the last connected participant of a joinable group call fails to properly end the call, the call will continue to be considered “active” even when there are no connected participants, and the active call will remain viewable for invited users. Anyone trying to join or rejoin that call would expect to see Person A (the last connected participant of the call) yet enter an empty call, which is undesirable.

### BRIEF SUMMARY

The subject disclosure provides for systems and methods for automatically terminating empty joinable group calls. A call is considered “joinable” when participants are permitted to connect to and disconnect from the call at will so long as the call remains active. A call is considered “active” as long as there are participants connected with one another via the call. A call is considered “empty” when it appears that the call is active but, in fact, there are no connected participants. Systems and methods in accordance with the subject disclosure provide for automatically (i.e., without user intervention) terminating a group call when it is determined that the call, though appearing active, is in fact empty.

One aspect of the present disclosure relates to a method for terminating empty joinable group calls. The method may include determining, at a first point in time, that there are at least two connected participants in a joinable group call. The method may include determining, at a second point in time that is later than the first point in time, that there is a single connected participant in the joinable group call. Based on determining, at the second point in time, that there is the single connected participant in the joinable group call, the method may include automatically terminating the joinable group call. The method may include transmitting a termination message to each participant of the joinable group call. The method may include causing display of the termination message on a respective device associated with each participant of the joinable group call.

Another aspect of the present disclosure relates to a system configured for terminating empty joinable group calls. The system may include one or more hardware processors configured by machine-readable instructions. The processor(s) may be configured to invite a plurality of participants to participate in a joinable group call. The processor(s) may be configured to determine, at a first point in time, that there are at least two connected participants of the plurality of participants participating in the joinable group call. In aspects, the joinable group call may comprise one or more of an audio feed and a video feed. The processor(s) may be configured to determine, at a second point in time that is later than the first point in time, that there is a single connected participant remaining in the joinable group call. The processor(s) may be configured to, based on determining, at the second point in time, that there is the single connected participant remaining in the joinable group call, automatically terminate the joinable group call. The processor(s) may be configured to transmit a termination message to the plurality of participants. The processor(s) may be configured to cause display of the termination message on a respective device associated with each of the plurality of participants.

Yet another aspect of the present disclosure relates to a non-transient computer-readable storage medium having instructions embodied thereon, the instructions being executable by one or more processors to perform a method for terminating empty joinable group calls. The method may include initiating a joinable group call at the request of a first participant of a plurality of participants. The method may include notifying each of the plurality of participants that the joinable group call has been initiated. The method may include receiving, at a first point in time, an indication that at least a second participant of the plurality of participants has connected with the first participant in the joinable group call. The method may include receiving, at a second point in time, an indication that a single participant of the plurality of participants remains connected in the joinable group call. Based on receiving, at the second point in time, the indication that the single participant of the plurality of participants remains connected in the joinable group call, the method may include automatically terminating the joinable group call. The method may include transmitting a termination message to each of the plurality of participants. The method may include causing display of the termination message on a respective device associated with each of the plurality of participants.

Still another aspect of the present disclosure relates to a system configured for terminating empty joinable group calls. The system may include means for determining, at a first point in time, that there are at least two connected participants in a joinable group call. The system may include means for determining, at a second point in time that is later than the first point in time, that there is a single connected participant in the joinable group call. Based on determining, at the second point in time, that there is the single connected participant in the joinable group call, the system may include means for automatically terminating the joinable group call. The system may include means for transmitting a termination message to each participant of the joinable group call. The system may include means for causing display of the termination message on a respective device associated with each participant of the joinable group call.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIGS. 1A-1G illustrate exemplary screen displays, according to certain aspects of the present disclosure.

FIG. 2 illustrates a system configured for terminating empty joinable group calls, in accordance with one or more implementations of the present disclosure.

FIG. 3 illustrates an exemplary flow diagram for terminating empty joinable group calls, according to certain aspects of the disclosure.

FIG. 4 illustrates an exemplary flow diagram for terminating empty joinable group calls, according to certain aspects of the disclosure.

FIG. 5 illustrates an exemplary flow diagram for terminating empty joinable group calls, according to certain aspects of the disclosure.

FIG. 6 is a block diagram illustrating an exemplary computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

As previously set forth, typical group call systems rely on the device of the last connected call participant to end a group call (e.g., an audio and/or video call). However, if the device of the last connected call participant loses connection (e.g., due to a dead battery, a change in reception, an improper closing of the group call app, or the like) and cannot or does not properly terminate the call, the group call may continue to be considered and viewable (for instance, in a call log) as active, even if nobody is on the call any longer.

In the past, this was not particularly problematic because users didn't have a list of “active” calls in their app. As such, whether a call was considered active or not was not known to users. However, with the introduction of joinable group calls (that is, group calls that permit invited participants to connect and disconnect at will as long as the call remains active), systems may display all, or at least some, active calls in the app so that users are aware of which calls they have been invited to participate in are joinable and which calls are not.

Accordingly, if the last connected participant of a joinable group call fails to properly end the call, the call will continue to be considered “active” even when there are no connected participants, and the active call will remain viewable for invited users. Anyone trying to join or rejoin that call would expect to see Person A (the last connected participant of the call) yet enter an empty call, which is undesirable.

To address this problem arising in the field of computer network technologies, the present disclosure includes systems and methods that no longer rely on the device of the last participant to end the call. Instead, logic resides on the call server which ends the call for all participants if it is determined that there is only one connected participant left in the call. Accordingly, it does not matter anymore if the last person lost did not or could not properly terminate the call.

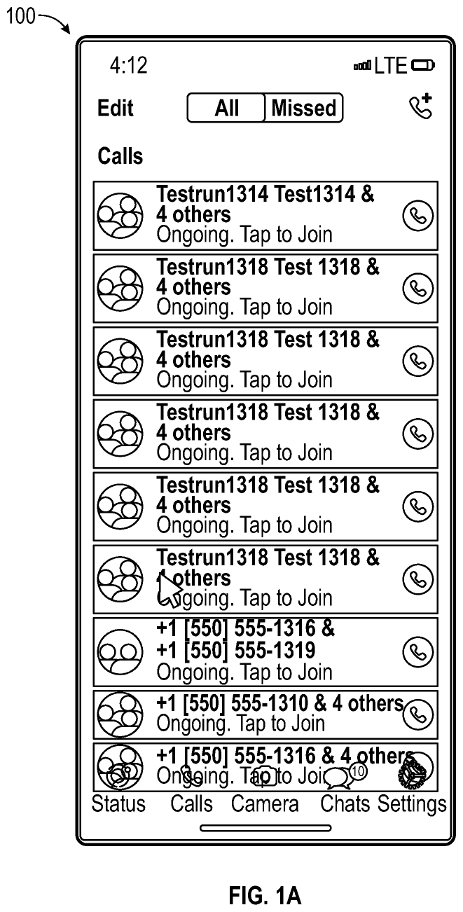

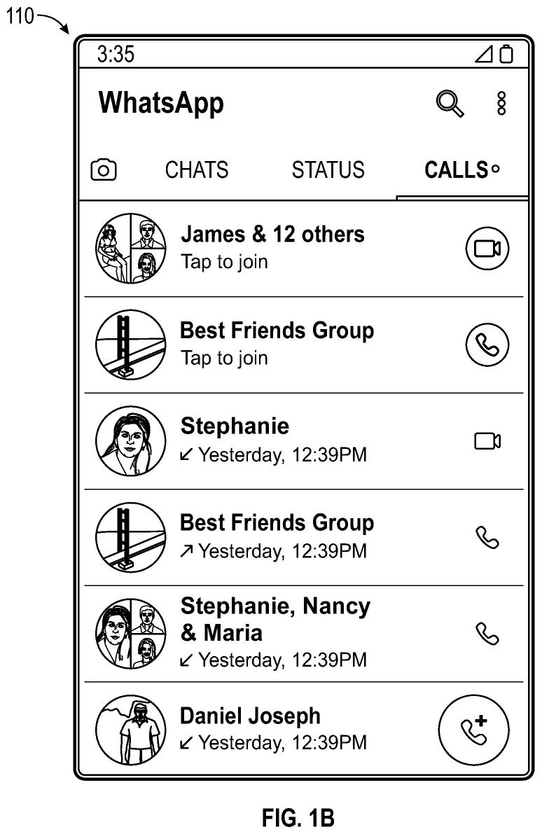

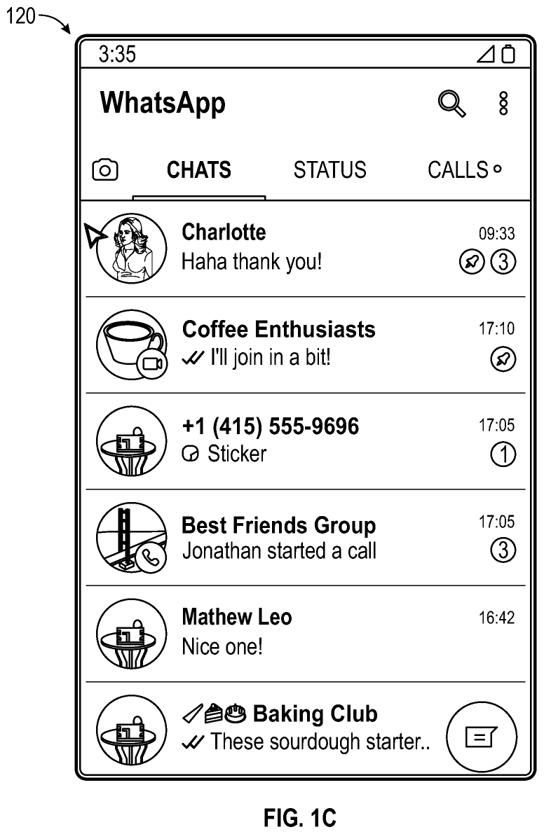

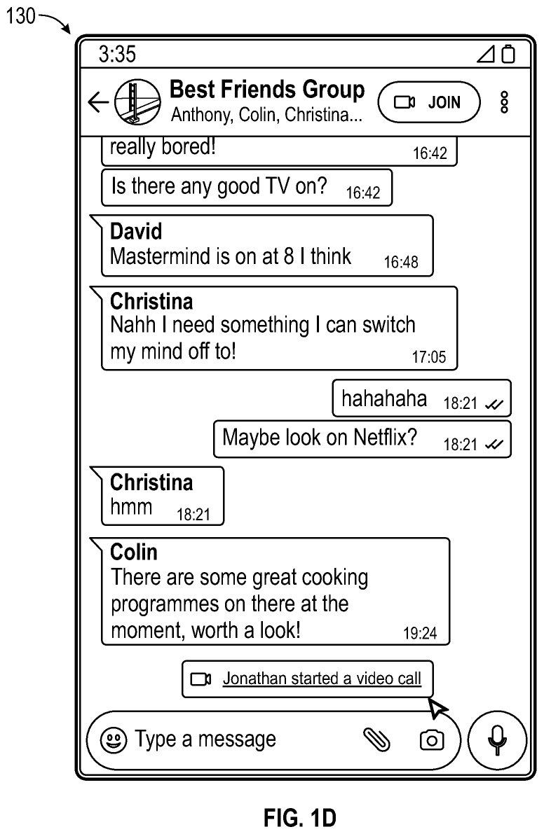

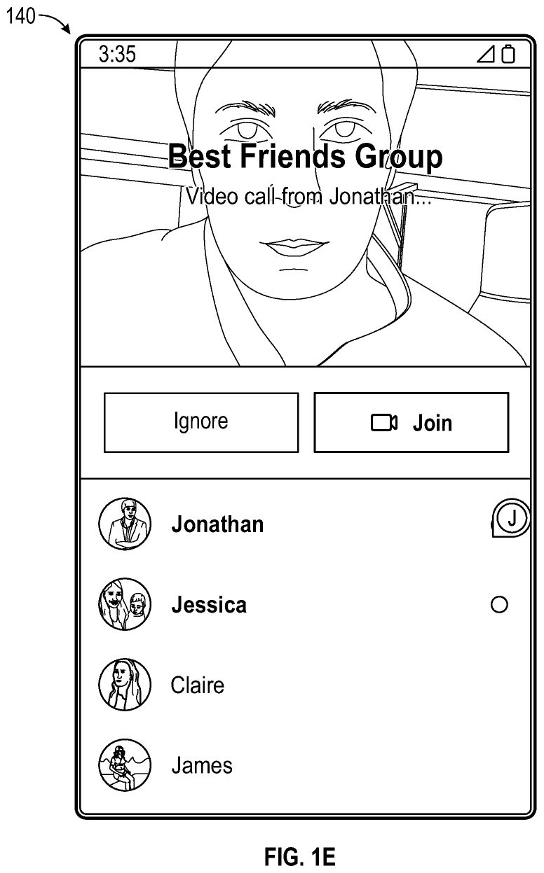

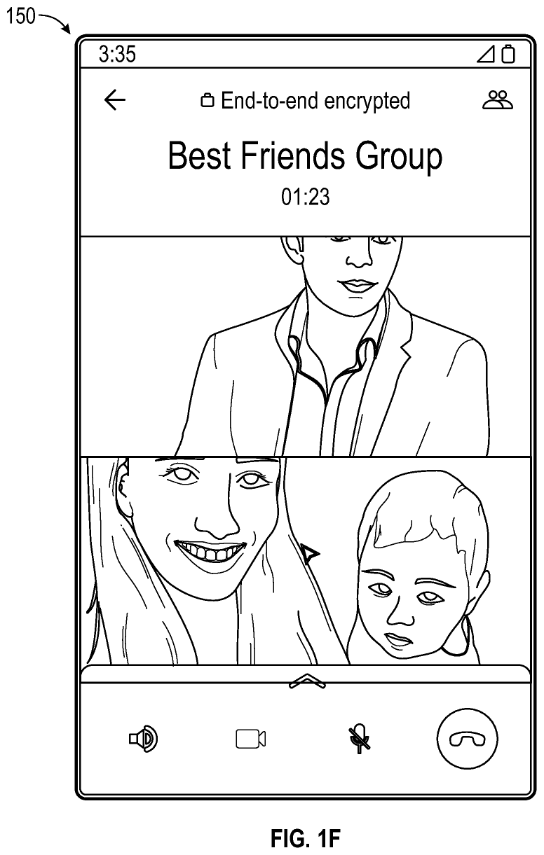

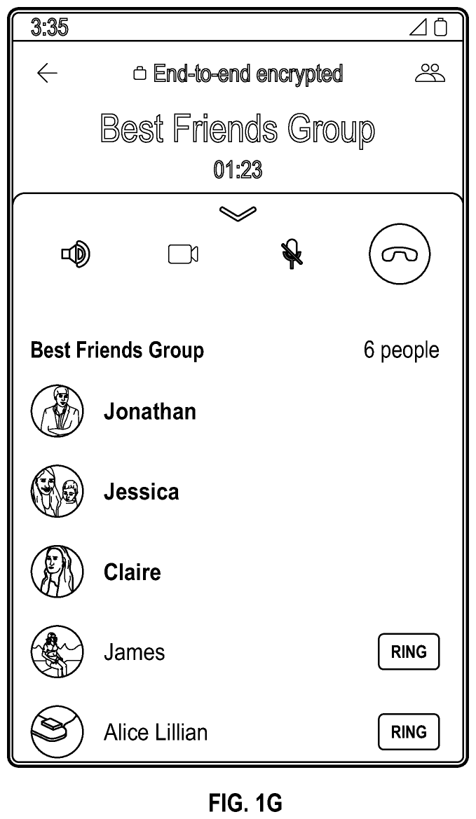

FIGS. 1A-1G illustrate exemplary screen displays illustrating various aspects of joinable group calls, according to certain aspects of the present disclosure. Referring to FIG. 1A, a call log interface 100 is displayed. As illustrated, the call log interface 100 shows a plurality of active, joinable group calls that a user may join upon selection thereof. FIG. 1B illustrates another call log interface 110 showing both joinable group calls and terminated and/or missed calls or group calls that were received within the time period shown on the screen. It should be noted that joinable group calls are shown both by the names of the participants and by the name of a group of participants. In aspects, the name of the group of participants may correspond to a chat group within the app. To join a group call from either of the screen displays in FIG. 1A or 1B, a user would simply select the call from within the call log listing.

FIG. 1C illustrates an exemplary screen display 120 showing a listing of chats a user is involved in from within the app. A green badge appears for each group that has a currently active joinable group call. To join the call, a user would simply select the group from the chat listing. For instance, FIG. 1C shows that there is an active joinable group call of the “Best Friends Group” currently ongoing. Selection of the group from the chat listing may redirect the user to a screen display 130 as shown in FIG. 1D. From the illustrated view, it can be seen that Jonathan initiated the call. Selection of the “JOIN” button near the top of the screen display may cause the user to join the group call.

FIG. 1E illustrates that, upon selection of the “JOIN” button of FIG. 1D, a user may be directed to a view 140 wherein his or her own video may be shown prior to joining into the group. Also, from this view it can be seen who the active call participants are (i.e., Jonathan and Jessica). Upon selecting the “JOIN” button of FIG. 1F, the user may be connected to the call and video of both participants to the joined call may be viewed. Selection of the arrow beneath the video images may expand the information about all participants, as shown in the screen display 150 of FIG. 1G.

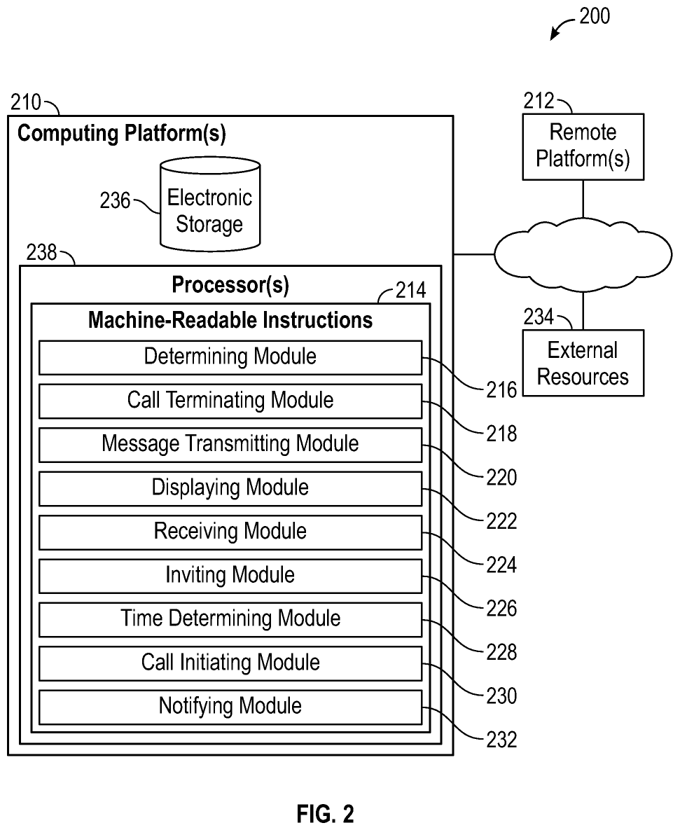

FIG. 2 illustrates a system 200 configured for terminating empty joinable group calls, according to certain aspects of the disclosure. In some implementations, system 200 may include one or more computing platforms 210. Computing platform(s) 210 may be configured to communicate with one or more remote platforms 212 according to a client/server architecture, a peer-to-peer architecture, and/or other architectures. Remote platform(s) 212 may be configured to communicate with other remote platforms via computing platform(s) 210 and/or according to a client/server architecture, a peer-to-peer architecture, and/or other architectures. Users may access system 200 via remote platform(s) 212.

Computing platform(s) 210 may be configured by machine-readable instructions 214. Machine-readable instructions 214 may include one or more instruction modules. The instruction modules may include computer program modules. The instruction modules may include one or more of determining module 216, call terminating module 218, message transmitting module 220, displaying module 222, receiving module 224, inviting module 226, time determining module 228, call initiating module 230, notifying module 232, and/or other instruction modules.

Determining module 216 may be configured determine, at a first point in time, that there are at least two connected participants (e.g., of a plurality of participants) participating in a joinable group call. In aspects, the joinable group call may comprise at least one of an audio feed and a video feed. Determining module 216 further may be configured to determine, at a second point in time that is later than the first point in time, that there is a single connected participant in the joinable group call.

Call terminating module 218 may be configured to, based on determining, at the second point in time, that there is a single connected participant in the joinable group call, automatically (i.e., without user intervention) terminate the joinable group call.

Message transmitting module 220 may be configured to transmit a termination message to each participant (of a plurality of participants) in the joinable group call indicating that the joinable group call has been terminated. In aspects, the message may include text that explicitly states that the call has been terminated. In aspects, the message may simple include a change in the manner the call is displayed in a call log to change the call from appearing active to appearing as a terminated call typically appears within the log. Any and all such variations, and any combination thereof, may be considered within the scope of embodiments of the present disclosure.

Displaying module 222 may be configured to cause display of a termination message on a respective device associated with each participant (of a plurality of participants) of the joinable group call. In aspects, displaying module 222 may be configured to cause display of the termination message in association with a call log on the respective device associated with each participant (of the plurality of participants) of the joinable group call.

Receiving module 224 may be configured to receive an indication that a first participant (of a plurality of participants) desires to initiate a joinable group call. Receiving module 224 may be configured to receive the indication that the first participant desires to initiate the joinable group call from a selection of the first participant made from within a group chat screen display. Receiving module 224 further may be configured to receive, at a first point in time, an indication that at least a second participant of the plurality of participants has connected with the first participant in the joinable group call. Receiving module 224 further may be configured to receive, at a second point in time, an indication that a single participant of the plurality of participants remains connected in the joinable group call.

Inviting module 226 may be configured to, invite a plurality of participants to participate in a joinable group call. Inviting module 226 further may be configured to, in response to receiving an indication that a first participant desires to initiate the joinable group call, invite each participant of the joinable group call to participate in the joinable group call. Inviting module 226 further may be configured to invite the plurality of participants to participate in the joinable group call in response to receiving an indication that the first participant of the plurality of participants desires to initiate the joinable group call.

In aspects, automatic termination of joinable group calls may be delayed until after all participants have been given sufficient time to accept the call. For instance, suppose Person A initiates a joinable group call with a group of college friends. Within seconds of the call initiation, suppose Person B, who is unable to join the call at that time, inadvertently accepts and joins the call and immediately thereafter leaves the call. In such an instance, where the other invited call participants may not have even yet seen that the call is being initiated, it is desirable to provide a period of time during which those other invited call participants can join the call without the call automatically terminating. As such, time determining module 228 may be configured to, prior to automatically terminating the joinable group call, determine that a pre-determined period of time has elapsed since each participant of the joinable group call was invited to participate in the joinable group call. In aspects, the pre-determined period of time may correspond to a ring period associated with the app (that is, an amount of time the app is configured to ring participants' devices). In aspects, automatic termination of joinable group calls may be delayed upon detecting that one or more invited participants are still ringing, regardless of passage of time. Any and all such variations, and any combination thereof, are contemplated to be within the scope of embodiments of the present disclosure.

Call initiating module 230 may be configured to initiate a joinable group call at the request of a first participant (of a plurality of participants) in the joinable group call. In aspects, the request of the first participant may be received from the first participant upon selection of a chat group within a joinable group call app.

Notifying module 232 may be configured to notify each of a plurality of participants that a joinable group call has been initiated. Such notification may be by virtue of ringing the devices of the invited participants, display of a textual message on the devices of the invited participants, a change in the call log associated with the app through which the joinable group call has been initiated, or the like.

In some implementations, computing platform(s) 210, remote platform(s) 212, and/or external resources 234 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 210, remote platform(s) 212, and/or external resources 234 may be operatively linked via some other communication media.

A given remote platform 212 may include one or more processors configured to execute computer program modules. The computer program modules may be configured to enable an expert or user associated with the given remote platform 212 to interface with system 200 and/or external resources 234, and/or provide other functionality attributed herein to remote platform(s) 212. By way of non-limiting example, a given remote platform 212 and/or a given computing platform 210 may include one or more of a server, a desktop computer, a laptop computer, a handheld computer, a tablet computing platform, a NetBook, a Smartphone, a gaming console, and/or other computing platforms.

External resources 234 may include sources of information outside of system 200, external entities participating with system 200, and/or other resources. In some implementations, some or all of the functionality attributed herein to external resources 234 may be provided by resources included in system 200.

Computing platform(s) 210 may include electronic storage 236, one or more processors 238, and/or other components. Computing platform(s) 210 may include communication lines, or ports to enable the exchange of information with a network and/or other computing platforms. Illustration of computing platform(s) 210 in FIG. 2 is not intended to be limiting. Computing platform(s) 210 may include a plurality of hardware, software, and/or firmware components operating together to provide the functionality attributed herein to computing platform(s) 210. For example, computing platform(s) 210 may be implemented by a cloud of computing platforms operating together as computing platform(s) 210.

Electronic storage 236 may comprise non-transitory storage media that electronically stores information. The electronic storage media of electronic storage 236 may include one or both of system storage that is provided integrally (i.e., substantially non-removable) with computing platform(s) 210 and/or removable storage that is removably connectable to computing platform(s) 210 via, for example, a port (e.g., a USB port, a firewire port, etc.) or a drive (e.g., a disk drive, etc.). Electronic storage 236 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 236 may include one or more virtual storage resources (e.g., cloud storage, a virtual private network, and/or other virtual storage resources). Electronic storage 236 may store software algorithms, information determined by processor(s) 238, information received from computing platform(s) 210, information received from remote platform(s) 212, and/or other information that enables computing platform(s) 210 to function as described herein.

Processor(s) 238 may be configured to provide information processing capabilities in computing platform(s) 210. As such, processor(s) 210 may include one or more of a digital processor, an analog processor, a digital circuit designed to process information, an analog circuit designed to process information, a state machine, and/or other mechanisms for electronically processing information. Although processor(s) 238 is shown in FIG. 2 as a single entity, this is for illustrative purposes only. In some implementations, processor(s) 238 may include a plurality of processing units. These processing units may be physically located within the same device, or processor(s) 238 may represent processing functionality of a plurality of devices operating in coordination. Processor(s) 238 may be configured to execute modules 216, 218, 220, 222, 224, 226, 228, 230, and/or 232, and/or other modules. Processor(s) 238 may be configured to execute modules 216, 218, 220, 222, 224, 226, 228, 230, and/or 232, and/or other modules by software; hardware; firmware; some combination of software, hardware, and/or firmware; and/or other mechanisms for configuring processing capabilities on processor(s) 238. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 216, 218, 220, 222, 224, 226, 228, 230, and/or 232 are illustrated in FIG. 2 as being implemented within a single processing unit, in implementations in which processor(s) 238 includes multiple processing units, one or more of modules 216, 218, 220, 222, 224, 226, 228, 230, and/or 232 may be implemented remotely from the other modules. The description of the functionality provided by the different modules 216, 218, 220, 222, 224, 226, 228, 230, and/or 232 described below is for illustrative purposes, and is not intended to be limiting, as any of modules 216, 218, 220, 222, 224, 226, 228, 230, and/or 232 may provide more or less functionality than is described. For example, one or more of modules 216, 218, 220, 222, 224, 226, 228, 230, and/or 232 may be eliminated, and some or all of its functionality may be provided by other ones of 216, 218, 220, 222, 224, 226, 228, 230, and/or 232. As another example, processor(s) 238 may be configured to execute one or more additional modules that may perform some or all of the functionality attributed below to one of modules 216, 218, 220, 222, 224, 226, 228, 230, and/or 232.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

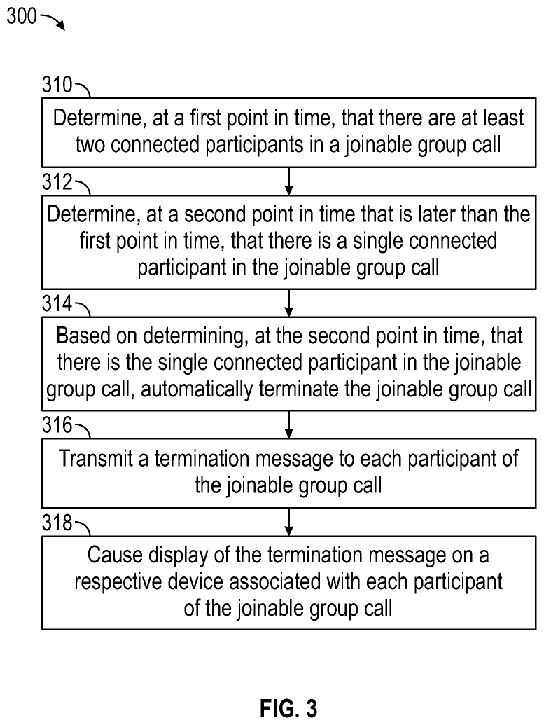

FIG. 3 illustrates an exemplary flow diagram (e.g., process 300) for terminating empty joinable group calls, according to certain aspects of the disclosure. For explanatory purposes, the exemplary process 300 is described herein with reference to FIGS. 1A-1G and 2. Further for explanatory purposes, the steps of the exemplary process 300 are described herein as occurring in serial, or linearly. However, multiple instances of the exemplary process 300 may occur in parallel.

At step 310, the process 300 may include determining, at a first point in time, that there are at least two connected participants in a joinable group call.

At step 312, the process 300 may include determining, at a second point in time that is later than the first point in time, that there is a single connected participant in the joinable group call.

At step 314, the process 300 may include, based on determining, at the second point in time, that there is the single connected participant in the joinable group call, automatically terminating the joinable group call.

At step 316, the process 300 may include transmitting a termination message to each participant of the joinable group call.

At step 318, the process 300 may include causing display of the termination message on a respective device associated with each participant of the joinable group call.

For example, as described above in relation to FIGS. 1A-1G and 2, at step 310, the process 310 may include determining, at a first point in time, that there are at least two connected participants in a joinable group call (e.g., through determining module 216 of the system 200 of FIG. 2). At step 312, the process 300 may include determining, at a second point in time that is later than the first point in time, that there is a single connected participant in the joinable group call (e.g., through determining module 216 of the system 200 of FIG. 2). At step 314, the process 300 may include, based on determining, at the second point in time, that there is the single connected participant in the joinable group call, automatically terminating the joinable group call (e.g., through call terminating module 218 of the system 200 of FIG. 2). At step 316, the process 300 may include transmitting a termination message to each participant of the joinable group call (e.g., through message transmitting module 220 of the system 200 of FIG. 2). At step 318, the process 300 may include causing display of the termination message on a respective device associated with each participant of the joinable group call (e.g., through displaying module 222 of the system 200 of FIG. 2).

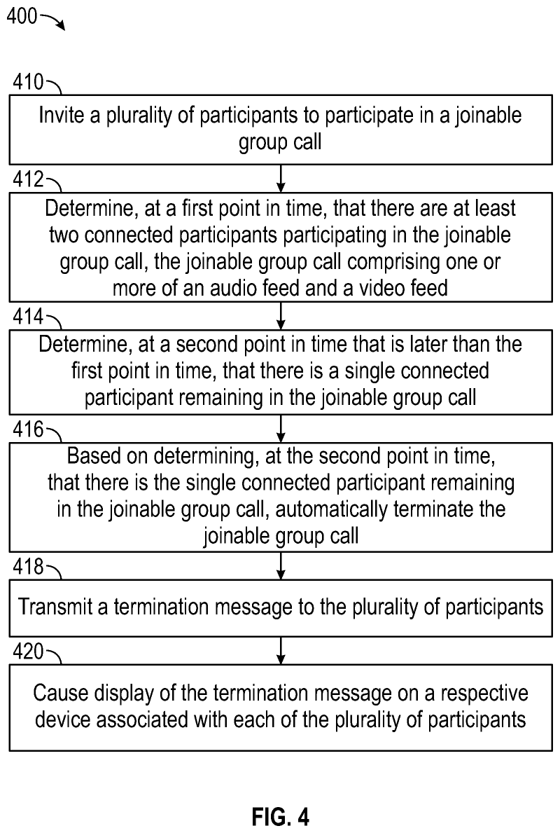

FIG. 4 illustrates an exemplary flow diagram (e.g., process 400) for terminating empty joinable group calls, according to certain aspects of the disclosure. For explanatory purposes, the exemplary process 400 is described herein with reference to FIGS. 1A-1G and 2. Further for explanatory purposes, the steps of the exemplary process 400 are described herein as occurring in serial, or linearly. However, multiple instances of the exemplary process 400 may occur in parallel.

At step 410, the process 400 may include inviting a plurality of participants to participate in a joinable group call.

At step 412, the process 400 may include determining, at a first point in time, that there are at least two connected participants of the plurality of participants participating in the joinable group call, the joinable group call comprising one or more of an audio feed and a video feed.

At step 414, the process 400 may include determining, at a second point in time that is later than the first point in time, that there is a single connected participant remaining in the joinable group call.

At step 416, based on determining, at the second point in time, that there is the single connected participant remaining in the joinable group call, the process 400 may include automatically terminating the joinable group call.

At step 418, the process 400 may include transmitting a termination message to the plurality of participants.

At step 420, the process 400 may include causing display of the termination message on a respective device associated with each of the plurality of participants.

For example, as described above in relation to FIGS. 1A-1G and 2, at step 410, the process 400 may include inviting a plurality of participants to participate in a joinable group call (e.g., through inviting module 226 of the system 200 of FIG. 2). At step 412, the process 400 may include determining, at a first point in time, that there are at least two connected participants of the plurality of participants participating in the joinable group call, the joinable group call comprising one or more of an audio feed and a video feed (e.g., through determining module 216 of the system 200 of FIG. 2). At step 414, the process 400 may include determining, at a second point in time that is later than the first point in time, that there is a single connected participant remaining in the joinable group call (e.g., through determining module 216 of the system 200 of FIG. 2). At step 416, based on determining, at the second point in time, that there is the single connected participant remaining in the joinable group call, the process 400 may include automatically terminating the joinable group call (e.g., through call terminating module 218 of the system 200 of FIG. 2). At step 418, the process 400 may include transmitting a termination message to the plurality of participants (e.g., through message transmitting module 220 of the system 200 of FIG. 2). At step 420, the process 400 may include causing display of the termination message on a respective device associated with each of the plurality of participants (e.g., through displaying module 222 of the system 200 of FIG. 2).

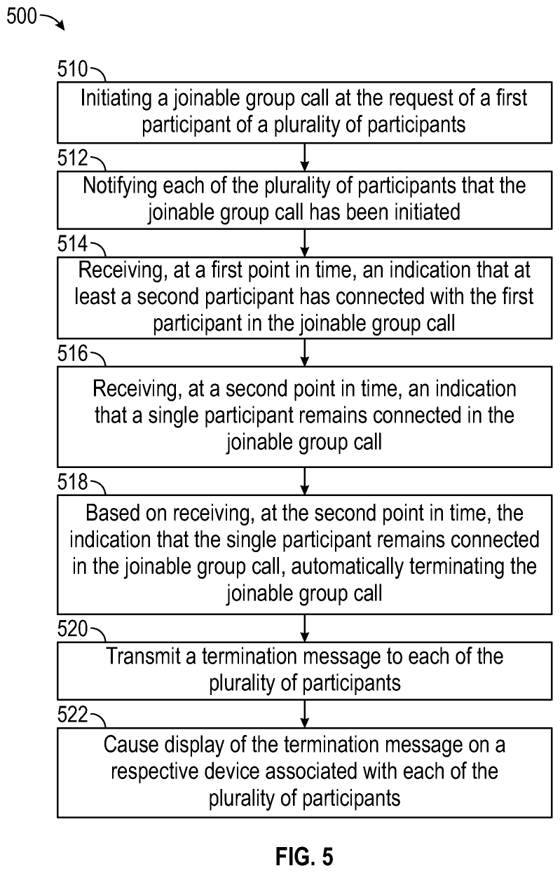

FIG. 5 illustrates an exemplary flow diagram (e.g., process 500) for terminating empty joinable group calls, according to certain aspects of the disclosure. For explanatory purposes, the exemplary process 500 is described herein with reference to FIGS. 1A-1G and 2. Further for explanatory purposes, the steps of the exemplary process 500 are described herein as occurring in serial, or linearly. However, multiple instances of the exemplary process 500 may occur in parallel.

At step 510, the process 500 may include initiating a joinable group call at the request of a first participant of a plurality of participants.

At step 512, the process 500 may include notifying each of the plurality of participants that the joinable group call has been initiated.

At step 514, the process 500 may include receiving, at a first point in time, an indication that at least a second participant of the plurality of participants has connected with the first participant in the joinable group call.

At step 516, the process 500 may include receiving, at a second point in time, an indication that a single participant of the plurality of participants remains connected in the joinable group call.

Based on receiving, at the second point in time, the indication that the single participant of the plurality of participants remains connected in the joinable group call, at step 518, the process may include automatically terminating the joinable group call.

At step 520, the process 500 may include transmitting a termination message to each of the plurality of participants.

At step 522, the process 500 may include causing display of the termination message on a respective device associated with each of the plurality of participants.

For example, as described above in relation to FIGS. 1A-1G and 2, at step 510, the process 510 may include initiating a joinable group call at the request of a first participant of a plurality of participants (e.g., through call initiating module 230 of the system 200 of FIG. 2). At step 512, the process 500 may include notifying each of the plurality of participants that the joinable group call has been initiated (e.g., through notifying module 232 of the system 200 of FIG. 2). At step 514, the process 500 may include receiving, at a first point in time, an indication that at least a second participant of the plurality of participants has connected with the first participant in the joinable group call (e.g., through receiving module 224 of the system 200 of FIG. 2). At step 516, the process 500 may include receiving, at a second point in time, an indication that a single participant of the plurality of participants remains connected in the joinable group call (e.g., through receiving module 224 of the system 200 of FIG. 2). At step 518, the process 500 may include, based on receiving, at the second point in time, the indication that the single participant of the plurality of participants remains connected in the joinable group call, automatically terminating the joinable group call (e.g., through call terminating module 218 of the system 200 of FIG. 2). At step 520, the process 500 may include transmitting a termination message to each of the plurality of participants (e.g., through message transmitting module 220 of the system 200 of FIG. 2). At step 522, the process 500 may include causing display of the termination message on a respective device associated with each of the plurality of participants (e.g., through displaying module 222 of the system 200 of FIG. 2).

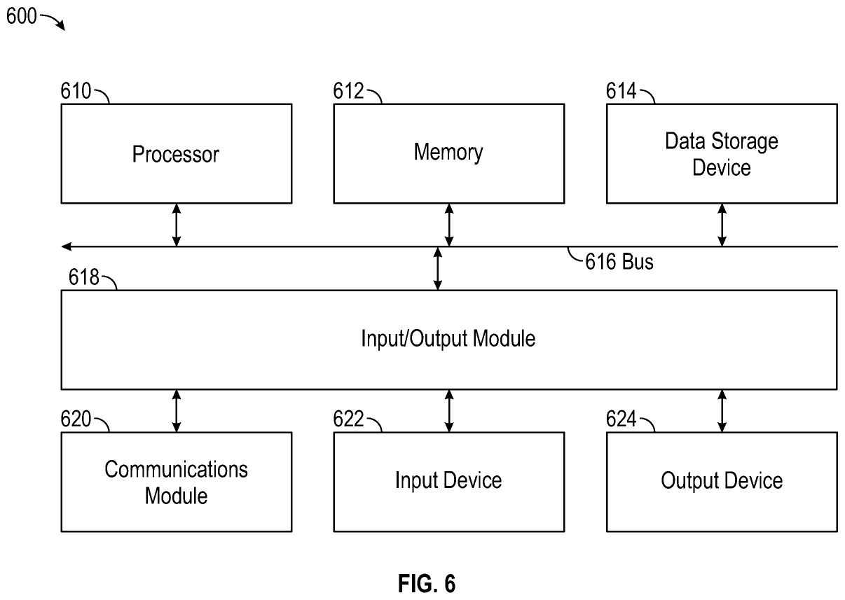

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 616 or other communication mechanism for communicating information, and a processor 610 coupled with bus 616 for processing information. By way of example, the computer system 600 may be implemented with one or more processors 610. Processor 610 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 612, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 616 for storing information and instructions to be executed by processor 610. The processor 610 and the memory 612 can be supplemented by, or incorporated in, special purpose logic circuitry.

The instructions may be stored in the memory 612 and implemented in one or more computer program products, i.e., one or more modules of computer program instructions encoded on a computer readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 612 may also be used for storing temporary variable or other intermediate information during execution of instructions to be executed by processor 610.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 614 such as a magnetic disk or optical disk, coupled to bus 616 for storing information and instructions. Computer system 600 may be coupled via input/output module 618 to various devices. The input/output module 618 can be any input/output module. Exemplary input/output modules 618 include data ports such as USB ports. The input/output module 618 is configured to connect to a communications module 620. Exemplary communications modules 620 include networking interface cards, such as Ethernet cards and modems. In certain aspects, the input/output module 618 is configured to connect to a plurality of devices, such as an input device 622 and/or an output device 624. Exemplary input devices 622 include a keyboard and a pointing device, e.g., a mouse or a trackball, by which a user can provide input to the computer system 600. Other kinds of input devices 622 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 624 include display devices such as a LCD (liquid crystal display) monitor, for displaying information to the user.

According to one aspect of the present disclosure, the above-described gaming systems can be implemented using a computer system 600 in response to processor 610 executing one or more sequences of one or more instructions contained in memory 612. Such instructions may be read into memory 612 from another machine-readable medium, such as data storage device 614. Execution of the sequences of instructions contained in the main memory 612 causes processor 610 to perform the process steps described herein. One or more processors in a multi-processing arrangement may also be employed to execute the sequences of instructions contained in memory 612. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 610 for execution. Such a medium may take many forms, including, but not limited to, non-volatile media, volatile media, and transmission media. Non-volatile media include, for example, optical or magnetic disks, such as data storage device 614. Volatile media include dynamic memory, such as memory 612. Transmission media include coaxial cables, copper wire, and fiber optics, including the wires that comprise bus 616. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads data, information may be read from the data and stored in a memory device, such as the memory 612. Additionally, data from the memory 612 servers accessed via a network the bus 616, or the data storage 614 may be read and loaded into the memory 612. Although data is described as being found in the memory 612, it will be understood that data does not have to be stored in the memory 612 and may be stored in other memory accessible to the processor 610 or distributed among several media, such as the data storage 614.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for terminating empty joinable group calls, the method comprising:
determining, at a first point in time, that there are at least two connected participants in a joinable group call;
determining, at a second point in time that is later than the first point in time, that there is a single connected participant in the joinable group call;
based on determining, at the second point in time, that there is the single connected participant in the joinable group call, automatically terminating the joinable group call;
transmitting a termination message to each participant of the joinable group call; and
causing display of the termination message on a respective device associated with each participant of the joinable group call.

2. The computer-implemented method of claim 1, wherein the joinable group call comprises at least one of an audio feed and a video feed.

3. The computer-implemented method of claim 1, wherein causing display of the termination message on the respective device associated with each participant of the joinable group call comprises causing display of the termination message in association with a call log on the respective device associated with each participant of the joinable group call.

4. The computer-implemented method of claim 1, further comprising receiving an indication that a first participant desires to initiate the joinable group call.

5. The computer-implemented method of claim 4, wherein receiving the indication that that the first participant desires to initiate the joinable group call comprises receiving the indication that the first participant desires to initiate the joinable group call from selection of the first participant made from within a group chat screen display.

6. The computer-implemented method of claim 4, further comprising, in response to receiving the indication that the first participant desires to initiate the joinable group call, inviting each participant of the joinable group call to participate in the joinable group call.

7. The computer-implemented method of claim 6, further comprising, prior to automatically terminating the joinable group call, determining that a pre-determined period of time has elapsed since each participant of the joinable group call was invited to participate in the joinable group call.

8. A system configured for terminating empty joinable group calls, the system comprising:
one or more hardware processors configured by machine-readable instructions to:
invite a plurality of participants to participate in a joinable group call;
determine, at a first point in time, that there are at least two connected participants of the plurality of participants participating in the joinable group call, the joinable group call comprising one or more of an audio feed and a video feed;
determine, at a second point in time that is later than the first point in time, that there is a single connected participant remaining in the joinable group call;
based on determining, at the second point in time, that there is the single connected participant remaining in the joinable group call, automatically terminate the joinable group call;
transmit a termination message to the plurality of participants; and
cause display of the termination message on a respective device associated with each of the plurality of participants.

9. The system of claim 8, wherein the one or more hardware processors are configured by the machine-readable instructions to cause display of the termination message on the respective device associated with each of the plurality of participants in association with a call log on the respective device associated with each of the plurality of participants.

10. The system of claim 8, wherein the one or more hardware processors are further configured by the machine-readable instructions to receive an indication that a first participant of the plurality of participants desires to initiate the joinable group call.

11. The system of claim 10, wherein the one or more hardware processors are configured to receive the indication that the first participant of the plurality of participants desires to initiate the joinable group call from a selection of the first participant made from within a group chat screen display.

12. The system of claim 10, wherein the one or more hardware processors are configured to invite the plurality of participants to participate in the joinable group call in response to receiving the indication that the first participant of the plurality of participants desires to initiate the joinable group call.

13. The system of claim 12, wherein the one or more hardware processors are further configured by the machine-readable instructions to, prior to automatically terminating the joinable group call, determine that a pre-determined period of time has elapsed since the plurality of participants was invited to participate in the joinable group call.

14. A non-transient computer-readable storage medium having instructions embodied thereon, the instructions being executable by one or more processors to perform a method for terminating empty joinable group calls, the method comprising:
initiating a joinable group call at the request of a first participant of a plurality of participants;
notifying each of the plurality of participants that the joinable group call has been initiated;
receiving, at a first point in time, an indication that at least a second participant of the plurality of participants has connected with the first participant in the joinable group call;
receiving, at a second point in time, an indication that a single participant of the plurality of participants remains connected in the joinable group call;
based on receiving, at the second point in time, the indication that the single participant of the plurality of participants remains connected in the joinable group call, automatically terminating the joinable group call;
transmitting a termination message to each of the plurality of participants; and
causing display of the termination message on a respective device associated with each of the plurality of participants.

15. The computer-readable storage medium of claim 14, wherein the joinable group call comprises at least one of an audio feed and a video feed.

16. The computer-readable storage medium of claim 14, wherein causing display of the termination message on the respective device associated with each of the plurality of participants comprises causing display of the termination message in association with a call log on the respective device associated with each of the plurality of participants.

17. The computer-readable storage medium of claim 14, wherein the method further comprises receiving an indication that the first participant of the plurality of participants desires to initiate the joinable group call.

18. The computer-readable storage medium of claim 17, wherein receiving the indication that that the first participant of the plurality of participants desires to initiate the joinable group call comprises receiving the indication that the first participant of the plurality of participants desires to initiate the joinable group call from a selection of the first participant made from within a group chat screen display.

19. The computer-readable storage medium of claim 18, wherein notifying each of the plurality of participants that the joinable group call has been initiated comprises inviting each of the plurality of participants to participate in the joinable group call in response to receiving the indication that the first participant of the plurality of participants desires to initiate the joinable group call.

20. The computer-readable storage medium of claim 19, wherein the method further comprises, prior to automatically terminating the joinable group call, determining that a pre-determined period of time has elapsed since each of the plurality of participants was invited to participate in the joinable group call.
